(19) United States
(12) Patent Application Publication
(10) Pub. No.: US 2014/0343998 A1
(43) Pub. Date: Nov. 20, 2014

(54) PROJECT ORIENTED CASH MANAGEMENT

(71) Applicant: Arthur Brian Andonian, Kalamazoo, MI (US)

(72) Inventor: Arthur Brian Andonian, Kalamazoo, MI (US)

(21) Appl. No.: 13/897,208

(22) Filed: May 17, 2013

(51) Int. Cl. G06Q 10/06; G06Q 40/00

(52) U.S. Cl. CPC G06Q 10/06313; G06Q 40/12
USPC 705/7.23

(57) ABSTRACT

A computer based method of determining the cash position of an entity using a spread sheet wherein the spread sheet is programmed to add all actual and scheduled receipts and expenditures associated with the tasks on a critical path of one or more projects underway by the entity on any selected date.

### TECHNICAL FIELD

This invention relates to a method for managing the cash position of an enterprise or entity engaged in one or more projects comprising many tasks that can be arranged on a critical path by scheduled dates of completion, payments and receipts.

### BACKGROUND

Most enterprises employ a staff of accountants and financial experts to manage their finances and produce the records necessary to operate a business and keep track of their cash receipts and payments. The present invention is not intended to replace such financial activities.

### SUMMARY

The present invention is intended to add a cash management method that provides additional information using scheduled as well as actual receipts and payments to determine the cash condition of an enterprise that is engaged in one or more projects comprising many tasks that can be arranged on a critical path of steps to be completed on scheduled dates and requiring cash payments and receipts. Small enterprises, or project managers in a large organization who have budgetary limitations, would benefit from a simple and more direct method to carry out their cash management responsibilities. The present method will enable such enterprises to determine their present and future cash availabilities and thereby know when their cash condition is or will be in surplus or shortage and whether they can undertake additional projects and still maintain a positive cash position.

Expressed succinctly the present invention is a method for determining the cash availability at any selected point in time for an entity having one or more projects under development comprising the following steps:
1. Determine the entity's cash on hand and credit line balance if any,
2. Determine the entity's overhead attributable to existing and/or future projects under management,
3. Establish a critical path for tasks to be carried out for each project including past and projected completion dates, payments and receipts associated with each critical path item,
4. Enter the foregoing information on a spread sheet in a computer and
5. Using algorithms entered on the spread sheet calculate the projected cash surplus/deficit that would result on any selected date using all of the foregoing information.

With knowledge of his current cash availability in terms of present and expected future receipts and payments, a manager could determine how best to use his existing cash resources and most importantly what amounts he must retain to satisfy his future obligations. He can also project his cash position for any future date depending on what he does with the cash on hand at the outset. He can also determine his current and future credit line requirements to assure that he has enough cash to continue the projects he has under management. He can update the information periodically as changes occur to the expected and realized dates, payments and receipts. He can also include information attributable to any additional project that he is considering to determine what effect the addition of that project would have on his cash position. The foregoing information about an entity's cash position would also be useful to an organization like a bank to determine whether to provide additional funding (credit line) to an entity. It would also be useful to existing or future investors who finance the entity.

### BRIEF DESCRIPTION OF THE DRAWINGS

FIG. 1 is an algorithm that indicates how the present method determines the real monetary condition of an enterprise at any point in time.

FIG. 2 is an algorithm that indicates how the present method takes into account the remaining amounts and dates for a project's future payables and receivables.

FIG. 3 is an algorithm that indicates how the present method takes into account the remaining amounts and dates for the future payables and receivables that are associated with an individual project's critical path items.

FIG. 4 is an algorithm that indicates how the present method takes into account the projected cost of a critical path item.

FIG. 5 is an algorithm that indicates how the present method takes into account the projected date of any future funds request.

FIG. 6 shows the information actually required by a bank for a building contract without identifying the parties involved. The same information entered on the spread sheet is used to carry out the method of the present invention.

FIG. 7 shows a summary of the current actual financial status of one project that happens to be in deficit.

FIG. 8 shows the cash flow projection over a three month period of all of the projects that the entity has underway.

### DETAILED DESCRIPTION

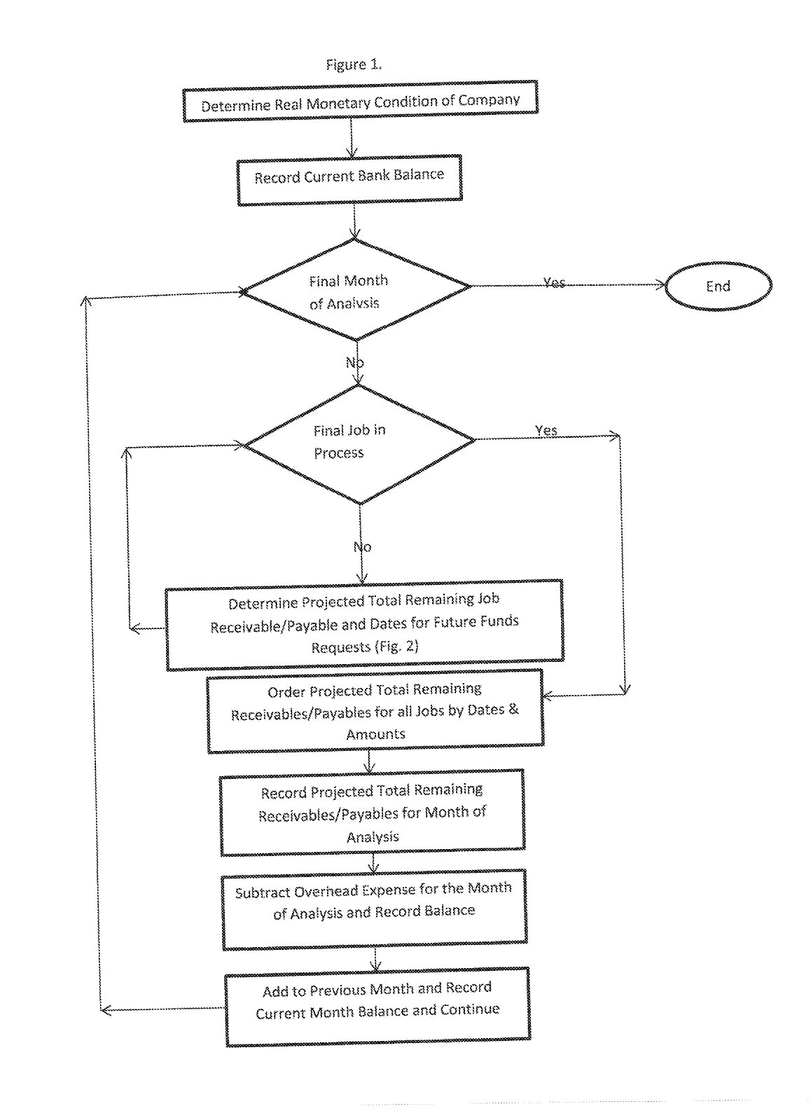

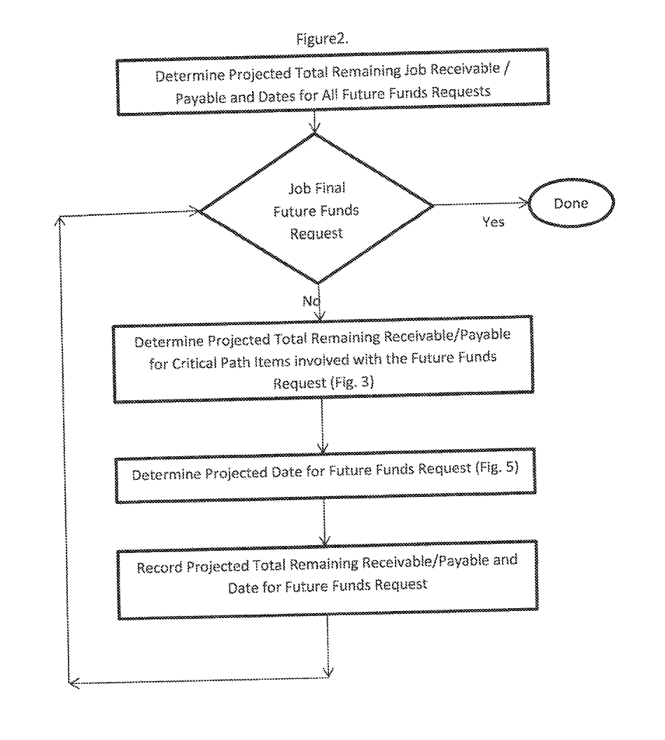

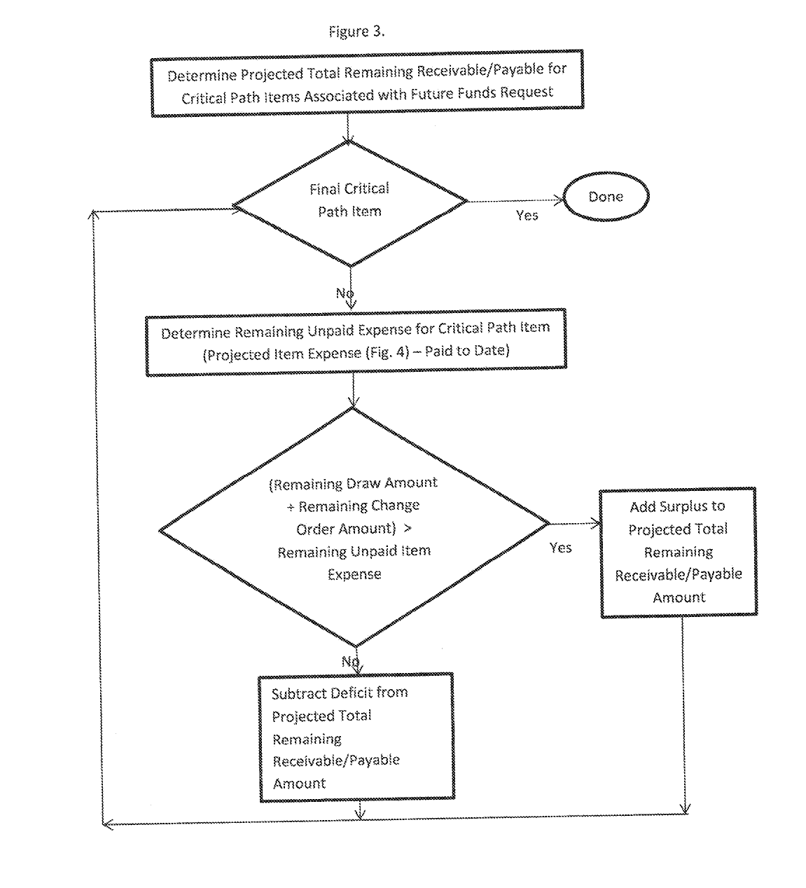

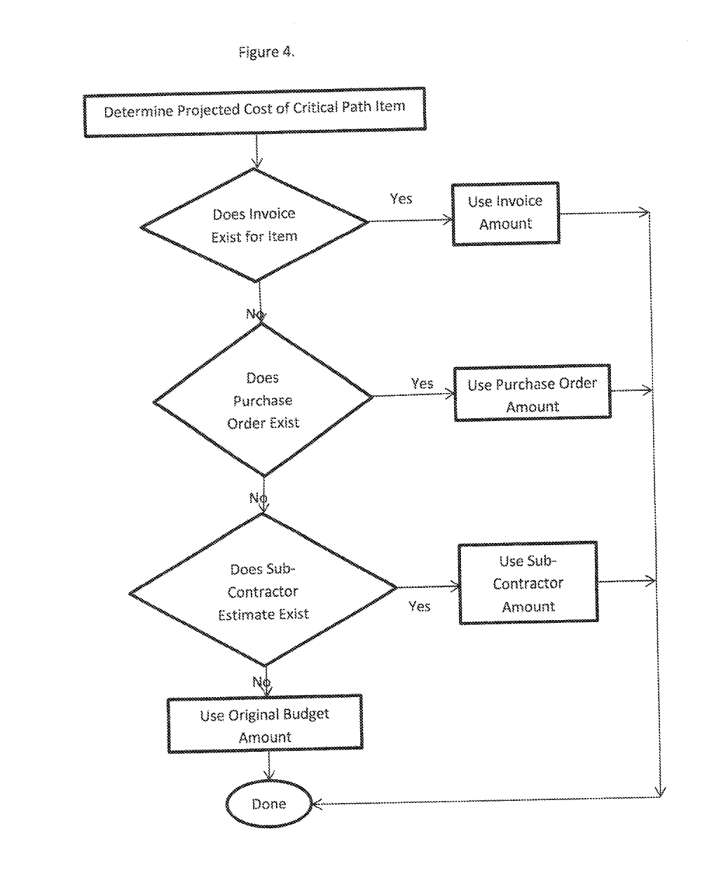

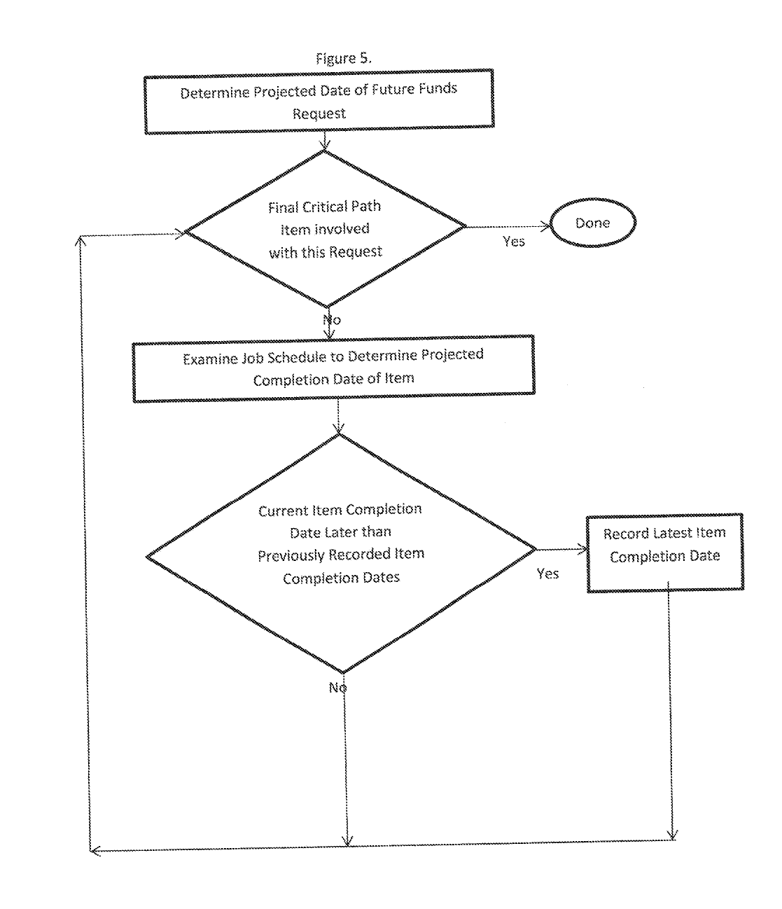

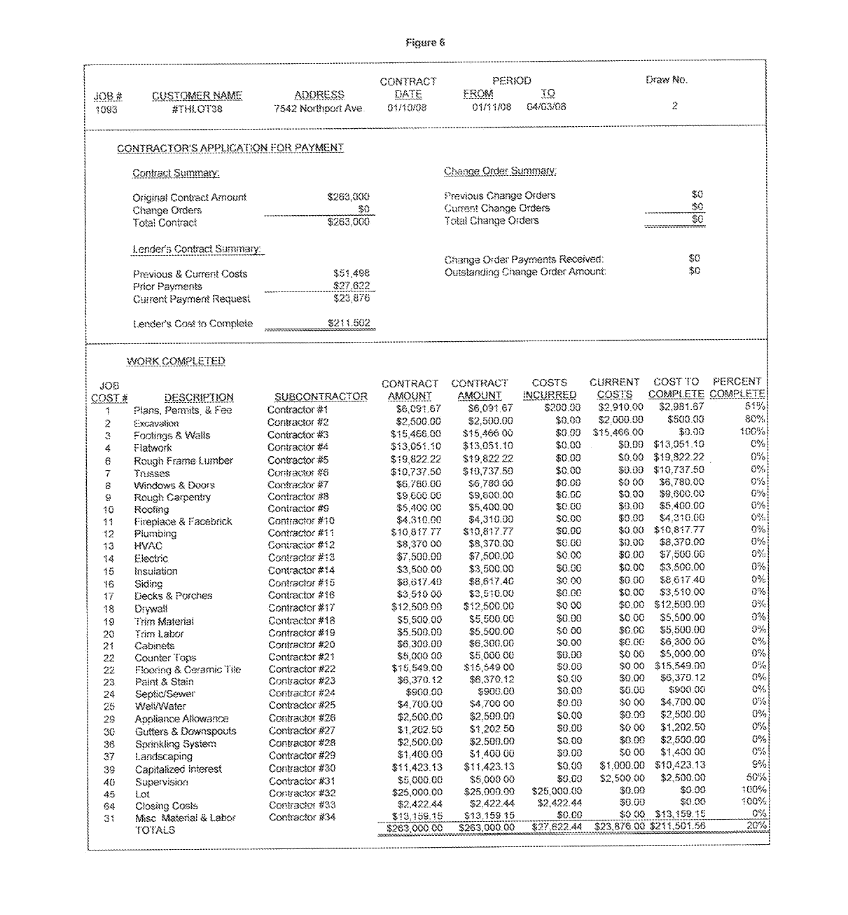

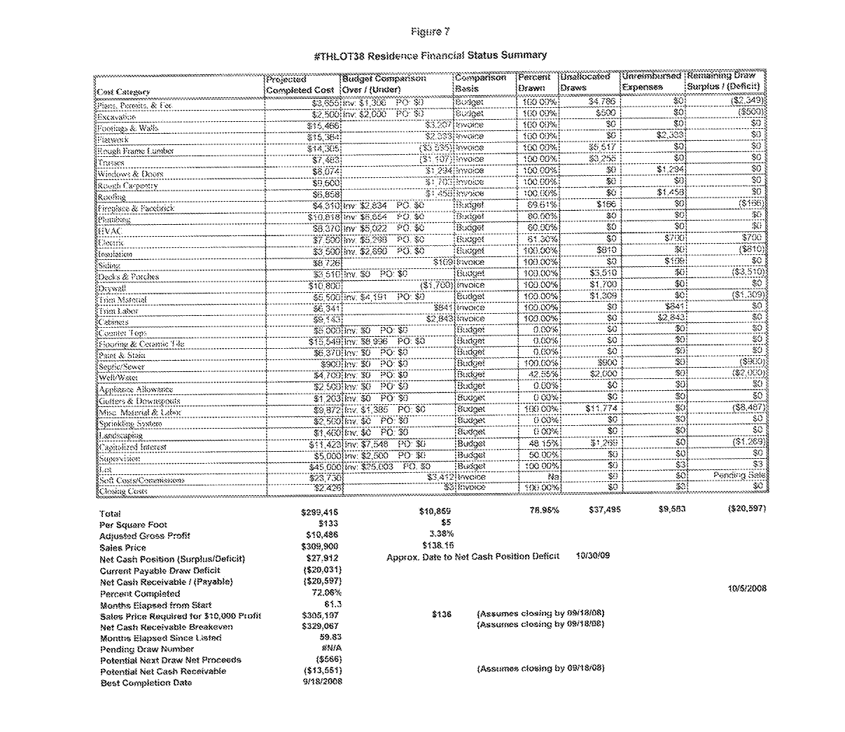

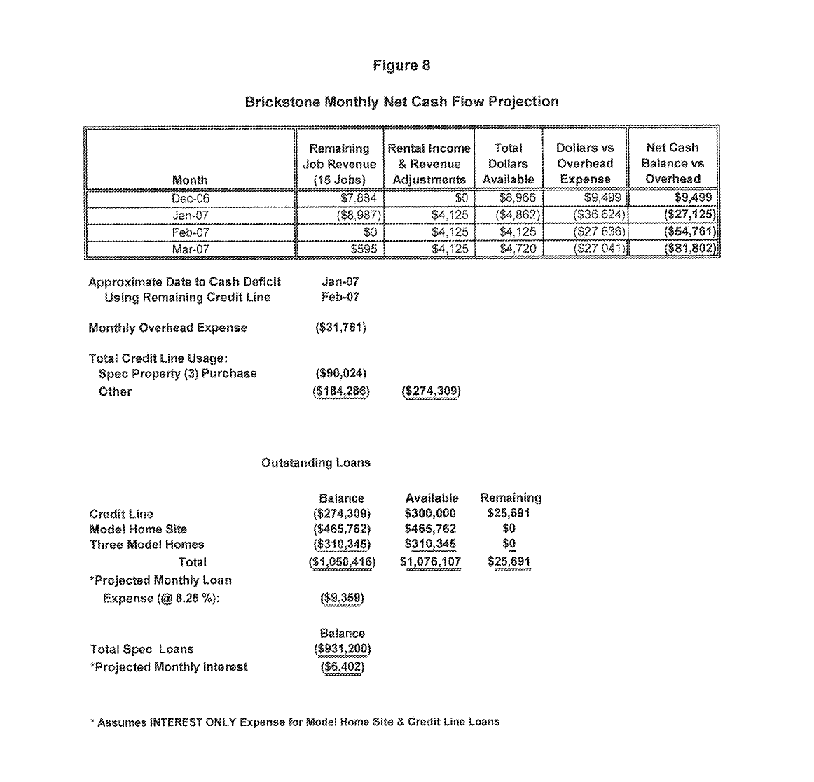

A small builder having a plurality of homes under construction is an ideal candidate to illustrate how the method of the present invention can be beneficially employed. He usually starts with a cash position and relies on a bank to finance his building operations on a project by project basis. For each project he undertakes he makes an application for a building loan from the bank. The information he provides to the bank includes all of the tasks required to carry out the project on a critical path that includes dates and costs to complete each task. Where he does not have actual committed dates of completion and costs he uses informed estimates. Using an actual example, without identifying the organizations that participated in the project, the information he supplied to the bank to obtain a second draw is shown in FIG. 6. He enters the same information on a spread sheet in a computer to establish a critical path for the project adding expected dates of completion and associated payments and receipts. Some of the information is based on actual contractual commitments from individual subcontractors or actual costs he incurs in carrying out the tasks himself or by using personnel included in his overhead. Other entries are estimates based on his knowledge of existing practices taking place in the environment in which he is carrying out his building operations. Using the spread sheet programmed with algorithms shown in FIGS. 1-5, he can determine his current cash position as shown in FIG. 7. To project his cash position over a three month period he can produce the information shown in FIG. 8. As shown for the actual example described above, the entity had a positive cash position initially but soon would be short of cash for the remainder of the three month period even considering the line of credit available from the entity's bank. To stay in business the builder would have to obtain an influx of cash from his own savings or other investors or find a way to cut or delay costs. He may even have to drop or renegotiate the terms of projects that are not yet underway.

The present method projects cash flow for all projects and monthly commitments based upon the remaining balance (total remaining revenue minus total projected cost) of each critical path item, expected completion date of each critical path item, and the proceeds already received for each critical path item. It also identifies any “out of trust” projects assuring that funds from a particular project are not being used for any other purpose.

The present method can be used by any entity that has one or more projects under management including project managers in large organizations working under budgetary constraints.

The benefits of the method of the present invention are many. First and foremost the user has a clear picture of his current cash position and what he can expect to happen in the future if he remains on his current course. The information he enters on the spread sheet is largely information he is already required to present to his bank for building loans. He also has an easy way of updating the information on the spread sheet to match future events or to take into account better information as it becomes available. The builder can also insert information on the spread sheet for any new project that he is considering to determine what the impact of the addition would be on his cash position at any point in time. He can tell if he actually has surplus funds at his disposal or will need additional funding to maintain his current operations. His lenders or investors would also benefit from such information to determine how their investments are doing and whether they should make additional funding available to the builder. Probably most important of all the present method reveals the actual financial condition of the builder and whether he is in or out of trust with his payment obligations. The recent collapse of the real estate business can partially be traced to the absence of information such as the present method can provide. Many loans were made and projects undertaken that were not financially sound because the information provided by the present method was not available when the decisions were made.

Specific details of the embodiments of the invention in the foregoing specification are for illustrative purposes only. The exclusive indicator of the invention is set forth in the claims that issue from this application or any subsequent correction. No limitation, element, property, feature advantage or attribute that is not expressly recited in a claim should limit the scope of the claim in any way.

1. A computer based method for determining the cash position of an entity at any point in time, the entity having one or more projects underway or planned wherein each project comprises a plurality of scheduled receivable and payable events on a critical path, by Employing a spread sheet in a computer programmed with algorithms that are capable of adding all actual and scheduled cash receipts and subtracting all actual and scheduled cash payments entered on the spread sheet on a current and/or any selected future date,
the method comprising the steps of
a. Entering the starting cash position of the entity on the spread sheet,
b. Entering the entity's overhead on the spread sheet,
c. Enter all receipts and payments previously received and all scheduled receivables and payables including using actually committed amounts and dates associated with each entry on the critical path of any and all projects underway and using informed estimates where actual commitments and dates of completion have not been established for any task on each critical path, and
d. Activate the algorithms to determine the cash position of the enterprise currently and/or one or more future dates.

2. The method of claim 1 further comprising the entity is a builder.

3. The method of claim I further comprising the entity is a project manager in a large organization.

4. The method of claim 1 further comprising the entity is an individual or employed manager of one or more projects comprising tasks and events associated with dates of completion, payments and receipts that can be arranged on a critical path.

5. A method for determining the cash availability at any selected point in time of an entity having one or more projects under development and thereby determining the ability of the entity to meet its present and future financial obligations comprising the following steps:
a. Determine the entity's cash on hand and credit line balance if any,
b. Determine the entity's overhead attributable to existing and/or future projects under management,
c. Establish a critical path for tasks to be carried out for each project including past and projected completion dates, payments and receipts associated with each critical path item,
d. Enter the foregoing information on a spread sheet in a computer and
e. Using algorithms entered on the spread sheet calculate the projected cash surplus/deficit that would result on any selected date using all of the foregoing information.
